(19) United States
(12) Patent Application Publication
(10) Pub. No.: US 2008/0223794 A1
(43) Pub. Date: Sep. 18, 2008

(54) Pillar Structure for Separating or Capturing Target Substance

(75) Inventors: Junta Yamamichi, Yokohama-shi (JP); Miki Ogawa, Machida-shi (JP); Kazuki Nakanishi, Kyoto-shi (JP)

Correspondence Address: FITZPATRICK CELLA HARPER & SCINTO, 30 ROCKEFELLER PLAZA, NEW YORK, NY, 10112, US

(73) Assignees: CANON KABUSHIKI KAISHA, Tokyo (JP); KYOTO UNIVERSITY, Kyoto-shi (JP)

(21) Appl. No.: 11/908,146

(22) PCT Filed: Mar. 16, 2006
(86) PCT No.: PCT/JP2006/305762

§ 371 Date: Apr. 18, 2008

(30) Foreign Application Priority Data
Mar. 18, 2005 (JP) 2005-079956

(51) Int. Cl. B01D 61/00; B01D 71/02; B01J 19/00; G01N 21/01; G01N 21/76; G01N 21/64

(52) U.S. Cl. 210/767; 210/500.23; 422/68.1; 422/82.05; 422/52; 422/82.08; 422/82.09; 73/64.56

(57) ABSTRACT

A structure having an opening communicating with an inner space is adapted for separating or capturing a substance introduced from the opening into the inner space. The structure comprises a hollow member having the inner space with the opening and plural pillars positioned mutually separately in the inner space. The pillars are formed of a material containing an inorganic oxide and different in composition from the hollow member.

### TECHNICAL FIELD

The present invention relates to a structure for separating or capturing a specified substance and a producing method therefor, and a separating element, a capturing element, a separating apparatus, and a detecting apparatus utilizing such structure.

### BACKGROUND ART

For analyzing a trace amount of a protein or nucleic acid, there have been used apparatuses utilizing electrophoresis or liquid chromatography, as represented by capillary electrophoresis or capillary liquid chromatography. Such apparatuses perform an analysis by filling a glass capillary of an internal diameter of 100 μm or less with a separating matrix. Such analysis utilizing a microspace has yielded an improvement in efficiency. Based on such a situation, it is now being proposed to utilize, instead of a microspace on the order of 100 μm, a microspace on the order of 10 μm or less.

For such a purpose, there is already known a method of utilizing a porous member, for example, a microfilter, such as a nitrocellulose membrane or a nylon membrane, paper, non-woven cloth or yarn, as a matrix, and a method of filling a reactor with beads to form a porous member. Such a porous member has an effective surface area much larger than an apparent surface area, thus being capable of fixing or carrying many captured components or interacting components on the surface.

However, such matrix is considered to contain, because of its structure, many closed spaces which the target substance cannot reach. Such spaces become wasted and cannot contribute to the reaction, with respect to the volume of the matrix, thus reducing the separating ability as a separating element or the efficiency as a capturing element. Also, in the bead filling method, when a solution to be inspected is injected and pressurized in a micro flow path over a long period of time or is used in a large amount, the beads themselves are moved to induce clogging, or the filled structure varies depending on the filling method. In addition, it is not well reproduced.

On the other hand, biosensors and biochips are being investigated as a measuring device utilizing an excellent biomolecule-recognizing ability of a biological substance or a biomolecule, and wide applications are anticipated not only in medical fields but also in the fields of ecology, foods and the like.

In general, a biosensor is constituted of a capturing element which recognizes and captures a substance to be measured (hereinafter called target substance), and a detecting element detecting a resulting physical or chemical change and converting it into a detectable signal, such as an electrical signal or an optical signal. There are known combinations of substances in living organisms that show mutual affinity, such as enzyme-substrate, antigen-antibody or DNA-DNA, and the biosensor utilizes a principle of fixing or carrying either member of such combinations on a matrix and utilizing it as a capturing component, thereby selectively measuring the other substance. Also, detecting elements of various types have been proposed, such as an oxygen electrode, a hydrogen peroxide electrode, an ion electrode, an ISFET (ion sensitive field effect transistor), an optical fiber or a thermistor. Also, there has been recently utilized a quartz oscillator, a SAW (surface acoustic wave) element or a plasmon resonance element, capable of detecting a mass change on the order of a nano gram.

Recently, investigations have actively been conducted to provide a microanalysis system, which integrates such a chemical analysis system on a glass or plastic substrate, which is, for example, several square centimeters. For example, investigations are being conducted in connection with a chip incorporating a very fine groove with an internal diameter of several hundred micrometers, namely a microspace, for supplying a liquid containing a reactive substance into the interior of a chip.

Such a microspace has the following advantages:
(1) a narrow space can reduce the time required for diffusion of substance;
(2) a large specific surface area with respect to a specimen volume enables a prompt chemical process utilizing an interface;
(3) a small heat capacity enables a rapid temperature change; and
(4) a reduced sample amount and energy required for analysis realizes a compact system,
   and a shorter period and a high precision of measurement are being tried through a scale reduction.

Also, the biosensor is desired for use in a small apparatus, which is portable or can be installed at any location and which can execute an advanced analysis within a short time. Therefore, a microanalysis system is an important target. Particularly in a capturing element, use of the aforementioned microspace is important and has an important effect. It is anticipated that a biosensor of a high sensitivity and a high precision can be obtained by applying, to the capturing element, a microspace capable of fixing or carrying a capturing component at a high concentration on a matrix and also of realizing smooth contact and recognition of the target substance by such a capturing component.

Among these, the use pillar-like members, provided on a base plate, as a column for chromatography has been investigated. For example, Analytical Chemistry, 2003, 75, p. 6244 reports a theoretical software analysis in a case where a conventional filled column is replaced by a column constituted of a regular array of porous pillars, and concludes that a column constituted of a regular array of porous pillars realizes a more compact column and a low separating impedance.

Separately, U.S. Patent Application Publication No. 2004/0125266 A1 (corresponding to Japanese Patent Application Laid-open No. 2004-170935) proposes a functional substrate, applicable to a molecular filter, a biochip or an optical device, formed by positioning pillar-like projections of an organic polymer on an organic polymer base plate. The reference states that the functional substrate can be prepared inexpensively by pressing, as the pillar-like projections are constituted of an organic polymer.

Also, apart from such pillars, Japanese Patent Application Laid-open No. 2004-99418 discloses the use of a porous gel as a separating medium, applicable to the analysis of cellular chemical substances, such as nucleic acids or proteins. An invention described in the reference intends to provide a material formed by covering a gel skeleton, having macropores, with an oxide layer matching a compound to be separated.

More specifically, it discloses a method for producing a porous material by preparing a porous gel via a sol-gel transition involving phase separation, then introducing a substance constituting a precursor of a metal oxide in such a porous material, and forming a covering metal oxide layer by a hydrolysis-polycondensation reaction. This document reports that a material, which can pass a solution with a pressure lower than in a filled column, has been obtained.

However, Analytical Chemistry, 2003, 75, p. 6244 mentioned above merely provides a theoretical analysis and does not include detailed specific disclosure on the material and method of producing the porous pillars.

Also, in U.S. Patent Application Publication No. 2004/0125266 A1, the pillar-like projections are formed with an organic polymer, and a molecule containing a corrosive component captured on the pillar-like projection may reduce the stability of the organic polymer. In addition, the base plate on which the pillar-like projections are formed is formed from the same material as the organic polymer constituting such pillar-like projections, thus imposing a restriction in forming the pillar-like projections thereon and leading to an increased cost.

Further, Japanese Patent Application Laid-open No. 2004-99418 discloses a separating medium utilizing a porous gel, which, however, does not utilize a pillar-like structure and a further improvement is desired for a separating a medium with a lower flow resistance.

### DISCLOSURE OF THE INVENTION

An object of the present invention is to provide an inexpensive structure having a low flow resistance and capable of stably separating or capturing a specified substance. Another object of the present invention is to provide a separating element, a separating apparatus, a capturing element and a detecting apparatus, utilizing a structure thus obtained. Still another object of the present invention is to provide a separating apparatus and a detecting apparatus, having an excellent light transmittance and applicable to an optical detection.

A structure provided by the present invention has an opening communicating with an inner space and is adapted for separating or capturing a substance introduced from the opening into the inner space, and it comprises a hollow member having the inner space and the opening, and plural pillars positioned mutually separately in the inner space, wherein the pillars are formed of a material containing an inorganic oxide and different in composition from the hollow member.

A separating element of the present invention, having an opening communicating with an inner space, adapted for separating a target substance contained in a specimen introduced from the opening into the inner space, comprises the structure mentioned above and a separating component, provided on a surface of the pillars, capable of interacting with the target substance to thereby separate the target substance from the specimen.

A separating apparatus of the present invention, adapted for separating a target substance contained in a specimen, comprises the separating element mentioned above, and a fluid displacement means, which causes fluid displacement within the inner space of the separating element.

A capturing element of the present invention, having an opening communicating with an inner space, adapted for capturing a target substance contained in a specimen introduced from the opening into the inner space, comprises the structure mentioned above and a capturing component, provided on a surface of the pillars, capable of capturing the target substance.

A target substance detecting apparatus of the present invention comprises the capturing element mentioned above, and detecting means for detecting that the target substance is captured by the capturing element.

A method for separating a target substance contained in a specimen of the present invention comprises a step of contacting the specimen with the separating element mentioned above, and a step of separating the target substance from the specimen, utilizing a physical or chemical interaction of the separating element with the target substance, the interaction being caused to occur in the contacting step.

A target substance detecting method for detecting a target substance contained in a specimen of the present invention comprises a step of contacting the specimen with the capturing element mentioned above, and a step of detecting a physical or chemical change resulting from a capture of the target substance by the capturing element.

A method for producing a structure provided, in a hollow member having an inner space, with pillars in the inner space, comprises a step of preparing a reaction solution dissolving an inorganic oxide precursor and having a composition regulated to form the pillars, a step of introducing the reaction solution to fill the inner space, and a step of inducing phase separation and sol-gel transition in the inner space to thereby form the pillars in a direction parallel to the gravitational direction.

The structure of the present invention is applicable for use as a separating element, such as a chromatographic column. In the structure of the present invention, the plural pillars provided in the hollow member having the inner space, being formed by a material containing an inorganic oxide, can show a stable separating or capturing function even for a corrosive substance. Also, since the hollow member having the inner space and the pillars are formed by materials of different compositions, an inexpensive material may be selected for the hollow member having the inner space while maintaining characteristics such as strength of the pillars, whereby the structure can be prepared from various materials.

The present invention can inexpensively provide a structure having a low flow resistance and capable of stably separating or capturing a specified substance. Also, the structure of the present invention can be used for providing a separating element, a separating apparatus, a capturing element or a detecting apparatus. Also, there can be provided a detecting apparatus having an excellent light transmittance, which is capable of applying an optical method for the detection of the target substance and is capable of a high sensitivity detection.

### BRIEF DESCRIPTION OF THE DRAWINGS

FIGS. 1A and 1B are schematic cross-sectional views of a structure of the present invention.

FIGS. 2A, 2B, 2C and 2D are schematic views showing examples of a structure having a microspace surrounded by a wall.

FIG. 3 is a schematic cross-sectional view of a structure in which pillars are formed in a part of a microspace.

FIG. 4 is a schematic view showing a capturing element according to Example 8.

FIG. 5 is a block diagram of an apparatus utilizing the capturing element of Example 8.

FIG. 6 is a schematic view showing a capturing element according to Example 9.

FIG. 7 is a schematic view showing a capturing element according to Example 10.

FIG. 8 is a schematic view showing an optical system of an SPR sensor.

### BEST MODES FOR CARRYING OUT THE INVENTION

A structure of the present invention has an opening communicating with an inner space and is adapted for separating or capturing a substance introduced through the opening. It includes a hollow member having the inner space and the opening, and plural pillars positioned mutually separately in the inner space, wherein the pillar is formed by a material containing an inorganic oxide and different in composition from the hollow member.

The inorganic oxide is preferably silica, and the pillars preferably contain carbon.

A substance constituting the object of separation or capture by the structure of the present invention is not particularly restricted, but is preferably selected from organic compounds and phosphoric acid compounds. Examples of such substances include biological substances contained in an organism, such as proteins, nucleic acids, sugars, peptides, amino acids, vitamins, or lipids, also substances related thereto, allergens, bacteria, viruses, and artificially synthesized pseudo biological substances. Examples also include substances constituting various plastics, fibers, paints, toners and the like, water-soluble specimens, such as a plating solution or an etching solution, and substances constituting functional materials, such as liquid crystals or photosensitive materials.

A separating element of the present invention, for separating a target substance in a specimen, is provided on the surface of the pillars in the structure of the above-described structure, with a component capable of physically or chemically interacting with the target substance to be separated. A separating apparatus for the target substance can be constructed by employing at least such a separating element and a fluid displacing means, which enables fluid displacement in the inner space of the separating element, in which plural pillars are provided. Such a separating apparatus may further include detection means for detecting a separated state of the target substance, and such a detection means is preferably an optical detection means.

The above-described structure can be advantageously utilized by providing a target substance capturing component on the surface of the pillars as a capturing element for capturing a target substance in a specimen. A detecting apparatus can be constructed by employing at least such a capturing element and a detection means for detecting a captured state, in the capturing element, of the target substance of the specimen. The detection means is preferably an optical detection means. More preferably, a detection means utilizes at least one selected from a fluorescence method, a luminescence method, a light absorption method, a refractive index method, a thermal conductivity method, a thermal lens method, a chemiluminescence method and a plasmon resonance method.

A target substance separating method utilizing the separating element includes at least a step of contacting the specimen with the separating element, and a step of separating the target substance, utilizing a physical or chemical interaction of the separating element and the target substance generated in the contacting step.

Also, a target substance detecting method utilizing the capturing element of the above-described constitution includes at least a step of contacting the specimen with the capturing element and a step of detecting a physical or chemical change generated by the contacting step.

Also, a method for producing the structure of the present invention includes at least a step of dissolving an inorganic oxide precursor in a solvent to prepare a reaction solution, a step of filling the inner space of the hollow member with the reaction solution, and a step of inducing a phase separation and a sol-gel transition in the inner space thereby forming pillars. The inorganic oxide precursor is preferably a metal alcoxide, more preferably a silicon alcoxide.

In the following, preferred embodiments of the present invention will be described in further details.

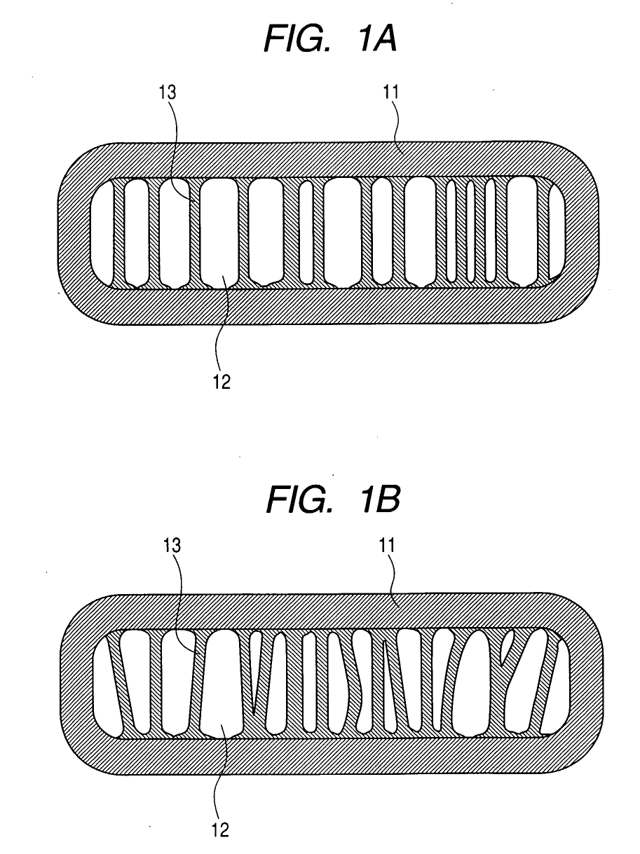

Structures in accordance the present invention are shown in FIGS. 1A and 1B. The structures shown in FIGS. 1A and 1B have plural pillars 13 in a hollow member 11 including an inner space 12. In the following, constituent parts of the structures will be explained further.

Hollow Member Having Inner Space

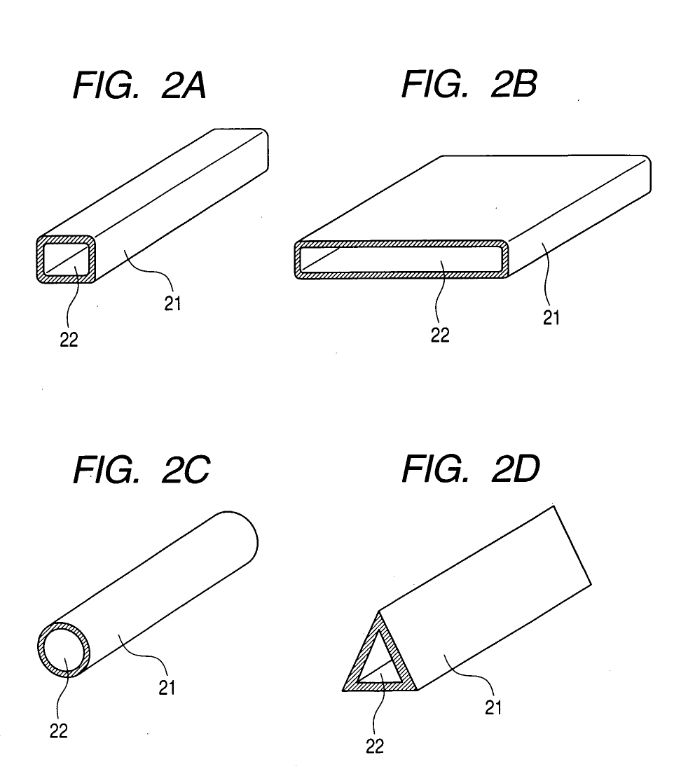

A structure in accordance with the present invention has a hollow member 21 having an inner space 22 as shown in FIGS. 2A, 2B, 2C and 2D, but the hollow member employed in the present invention is not limited to such shapes as long as it has an inner space and an opening communicating therewith. However, in order to form plural pillars in a more parallel manner, two inner faces of the hollow member having the inner space are preferably parallel. Of the examples shown in FIGS. 2A to 2D, it is easier to form parallel pillars in those shown in FIGS. 2A and 2B than in those shown in FIGS. 2C and 2D. In the present invention, an integral hollow member in which a wall surrounding the inner space is formed continuously can be employed advantageously, but a hollow member may also be formed by adjoining an upper substrate to a flow trough or the like or by adjoining an upper substrate and a lower substrate with a spacer constituting a side wall. However, the hollow member preferably has an opening for introducing a reaction solution to fill the inner space, at least at the time of filling, in a producing method to be explained later. Examples include a microtube and a glass capillary, but any member capable of containing the reaction solution in the inner space to form pillars in the inner space may be employed without restriction, and the material and the shape can also be suitably selected. Also, it is preferable to form at least a part of the hollow member as a light-transmissive area to be used for the detection of the target substance, for the purpose of utilizing an optical detection to detect the target substance in a state captured by the capturing element. For example, the entire hollow member may be formed from a light-transmissive material such as glass, thereby enabling detection with optical detecting means.

Also the inner space preferably has a size of 100 nm-1 mm, in view of the liquid flow at a practical speed and the uniformity of the generated pillar structure. In an inner space smaller than 100 nm, the pillar structure formation by a phase separation will be difficult, while in an inner space larger than 1 mm it will be difficult to avoid deformation or unevenness in the pillar structure because of the influence of gravity. For example, in case the hollow member has a tubular form with a circular cross-section (cross-section perpendicular to the direction of liquid flow), the internal diameter thereof is preferably selected within the above-mentioned range. Also, in case the tubular hollow member has a triangular or tetragonal cross-section, the length of the shortest side or the longitudinal size of pillars to be formed is preferably within the aforementioned range.

Pillar

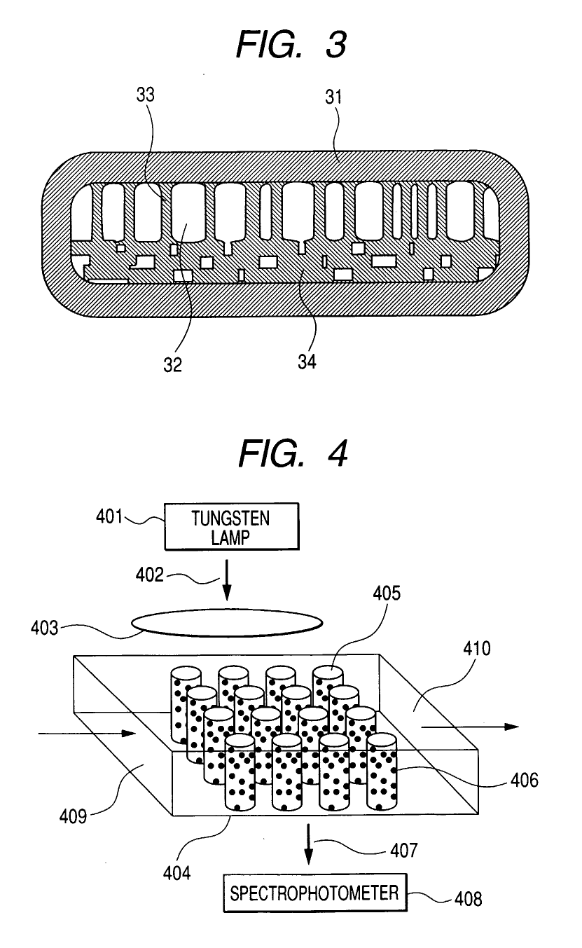

The structure of the present invention has, in the aforementioned inner space, plural pillars 13 as shown in FIGS. 1A and 1B. Each pillar extends in the inner space 12, from a base portion on an inner wall of the hollow member 11 and is bonded at the other end also to an internal wall of the inner space. The structure of the present invention has a plurality of pillars adjoined at both ends to the upper and lower inner walls, but may also include a pillar fixed to the upper or lower inner wall at only one end and not reaching the lower or upper inner wall at the other end. Also, the pillars may be formed in a part of the inner space, and the effect of the present invention is not diminished even when, as shown in FIG. 3, the inner space 32 of a hollow member 31 includes both pillars 33 and a three-dimensional network porous region (three-dimensional network structure) 34. The pillars in the present invention have a diameter of 100 nm-1 mm, and are arranged with a gap of 100 nm-1 mm. The height of the pillars is influenced by the size of the hollow member with the inner space, but is preferably in a range of 100 nm-1 mm. The cross-sectional shape of pillars is generally circular or oval, but may also be a modified shape thereof. A longitudinal cross-sectional shape is generally rectangular or square, or is a rectangular shape in which an upper or lower part is wider than at the center, but may also be a modified shape thereof. Also, the pillars represent a volume proportion in the inner space of 94% or less depending on the producing method. However, for achieving a high specific surface area and a low flow resistance, in order to be advantageously applicable to a separating element or a capturing element, the volume proportion is preferably 50% or less and more preferably 10-50%. The pillars may be positioned in various arrangements, but, for reducing the flow resistance for a fluid, in a regular arrangement in which plural pillars are positioned substantially in a matrix pattern, as in the case of pillars 405 shown in FIG. 4.

Such a fine structure can be formed by utilizing phase separation and sol-gel transition, generated in a process in which the inorganic oxide precursor undergoes a hydrolysis/polycondensation reaction.

The material constituting the pillars includes inorganic oxides, such as silica, alumina or titania. In the present invention, the material constituting the pillars is not particularly restricted as long as it has a composition different from that of the material constituting the hollow member having the inner space, but preferably includes silica, depending on chemical resistance, mechanical strength and the ease of carrying an interacting component or a capturing component to be explained later.

In the present invention, the material constituting the pillars and the material constituting the hollow member having an inner space have different compositions of material. Having different compositions means not only the case where the materials have the same constituent elements but are different in composition, but also the case where the materials have different constituent elements, namely where the hollow member having an inner space and the pillars are formed from different materials. Also, for structural control at the pillar formation, the pillars are preferably formed from a material including carbon, such as a material having an alkyl group.

In the present invention, as will be explained later in the producing method, the hollow member having an inner space and the pillars are formed with materials of different compositions. It is therefore rendered possible, for example, to employ an inexpensive material for the hollow member having an inner space while maintaining characteristics of the pillars, such as strength. Limitations on production are thus reduced compared to cases where the hollow member and the pillars are formed from the same material, such as an organic polymer, thus allowing to provide an inexpensive structure.

A separating element of the present invention is explained as follows.

Separating Element

The separating element of the present invention is characterized in having, on a surface of the pillars provided in the structure, a component capable of interacting (hereinafter referred to as interacting component) physically or chemically with a target substance. The separating element of the present invention is usable, for example, as a capillary column for chromatography, and, in this case, the pillar surface constitutes a stationary phase in the chromatography. The separating element of the present invention, having plural fine pillars arranged with a small gap, can increase the specific surface area and reduce the diffusion distance of the target substance in a specimen to the stationary phase. Also, the low flow resistance can improve the liquid supplying property.

Component Interacting with Target Substance

The target substance separating component in the invention, capable of physically or chemically interacting with the target substance, can be a hydrophobic component, a hydrophilic component, a component having an adsorbing ability, or a component having an ion exchange ability, but such examples are not restrictive. Such a component can be carried on the pillar surface by being contained in advance in an inorganic oxide precursor to be explained later in the producing method. It can also be introduced after the pillars are formed by a reaction of a surface modifying agent. For example, in case silica is employed as the inorganic oxide, a silanol group is exposed on the surface and can be reacted with a surface modifying agent, such as a silane coupling agent, having a component interacting with the target substance. The surface modifying agent can be suitably selected so as to obtain a desired surface (interacting) property, and, for example, a component having an octadecyl group can improve the hydrophobicity of the stationary phase. Also, in order to reduce unnecessary interaction, a capping treatment may be applied on the excessive silanol group.

A separating apparatus of the present invention is explained as follows.

Separating Apparatus

A separating apparatus of the present invention is characterized in including the aforementioned separating element and a fluid displacement means. An ordinary capillary column for chromatography has a three-dimensional network structure in a capillary. It separates a substance, utilizing a difference of a surface thereof in a physical or chemical interaction. A high flow rate necessitates an increased pressure for liquid supply, thus requiring a high-performance pump system. The separating apparatus, utilizing the separating element of the present invention, has a low flow resistance and can reduce the liquid supplying pressure, as the separating element has a two-dimensional pillar structure. Also, due to its high light transmittance, even if an optical detection system such as UV-VIS is utilized, a high sensitivity and low liquid supply pressure can be achieved while maintaining the separating ability.

A capturing element of the present invention is explained as follows.

Capturing Element

The capturing element of the present invention is characterized in having, on the surface of the pillars in the structure, a capturing component for capturing a target substance. The capturing element of the present invention, having plural fine pillars arranged with a small gap, has a large surface area and can carry a large amount of the capturing component. Also, it can reduce the diffusion distance of the target substance in a specimen to the capturing component, thereby improving the efficiency as a reaction field. Also, it has a high light-transmittance, which makes it suitable for an optical detection.

Capturing Component

The capturing component to be employed in the present invention is a substance involved in the selection of the target substance in a specimen. For example, it can be a substance directly reacting selectively with the target substance in the specimen (such as so-called receptor or an antibody molecule), a substance involved in the reaction with the target substance (for example, a substance having a selective catalytic action on the reaction of the target substance), or a substance deactivating substances other than the target substance in the specimen. Also, such a capturing component may have a function relating to the indication of the presence/absence or level of detection, for example, a function of color generation by reacting with a substance released by the receptor or a residual substance. The capturing component to be employed in the present invention, though not particularly restricted, can for example be an enzyme, a sugar chain, a catalyst, an antibody, an antigen, a nucleic acid, a gene, a color-developing reagent and the like, but such examples are not restrictive.

A detecting apparatus of the present invention having the capturing element is explained as follows.

Detecting Apparatus

A biosensor is generally constituted, as explained before, of a capturing element and a detecting element. The detecting element detects and displays a reaction resulting when the capturing element recognizes a target substance to be specified via a change in the amount of light, current, voltage, mass or heat. As the detecting element, various elements are already known, such as an oxygen electrode, a hydrogen peroxide electrode, an ISFET, an optical fiber, a SAW, and a thermistor. The detecting apparatus of the present invention is characterized in utilizing a highly efficient capturing element, and a detecting method to be combined is not limited to these examples. However, the capturing element of the present invention, having an excellent light-transmittance, is preferably combined with an optical detecting element utilizing at least one of the optical detecting methods, such as a fluorescence method, a luminescence method, a light absorption method, a refractive index method, a thermal conductivity method, a thermal lens method, a chemiluminescence method and a plasmon resonance method. In case of a combination with an optical detecting element, an optical system is preferably constructed so that an incident light and an emerging light to be detected are substantially parallel to the longitudinal axis of the pillar structure.

Also, the capturing component may be used in combination, and, for example, the detection apparatus may be constructed as a composite enzyme sensor, an antibody-enzyme sensor or an enzyme-bacteria hybrid sensor.

The object of measurement for the detecting apparatus of the present invention need not necessarily be a target substance with which the capturing component reacts directly, but can be a substance measured indirectly. For example, a measurement is made possible by detecting a target substance specifically present in the object of the measurement. Therefore, the object of the measurement is not limited to a biological substance, and a size thereof is also not limited. However, the target substance is preferably a biological substance contained in an organism, such as a sugar, a sugar chain, a protein, a peptide, an amino acid, an antibody, an antigen or a pseudo antigen, a vitamin, a gene, a nucleic acid, an allergen, a bacterium, a virus, a related substance thereof, and an artificially synthesized pseudo biological substance.

A separating method of the present invention is explained as follows.

Separating Method

The separating method of the present invention will be explained for a case of employing a silica pillar structure. A silica pillar structure, including arranged pillars, is considered, in comparison with a column three-dimensionally filled with particles, as a structure having cylindrical particles arranged between parallel flat plates. However, such a structure can be retained without depending on a filling method, and a separating ability is determined by the diameter and the gap of the pillars, designed in advance. The separation is realized by that specimen molecules, dissolved in a mobile phase solution, repeat distribution with the surface of pillars constituting the stationary phase (distribution mode) as in conventional liquid chromatography, or that the specimen molecules cause a molecular diffusion into the pores of the pillars depending on the molecular weight (size exclusion mode). The number of theoretical plates per unit length increases as the pillar diameter decreases, and the flow resistance of the column decreases as the distance between pillars decreases. The number of theoretical plates shows a maximum with respect to the linear flow rate of the mobile phase according to the ordinary van Deemter formula. Therefore, the separating efficiency reaches a maximum at about the linear flow rate corresponding to such a maximum. Also, the pillar surface requires a chemical modification corresponding to the chemical properties of the molecule to be separated.

Substance separation in a specimen is executed by assembling the silica pillar structure, including the arranged pillars, as a column in a liquid chromatography apparatus, and by flowing a liquid specimen. The specimen can be, for example, a biological substance contained in an organism, such as a protein, a nucleic acid, a sugar, a peptide, an amino acid, a vitamin or a peptide, a substance related thereto, or an artificially synthesized pseudo biological substance. The specimen can also be various plastics or fibers, a paint with a complex composition, a toner, a water-soluble specimen, such as a plating solution or an etching solution, or a functional material, such as a liquid crystal or a photosensitive material.

A detecting method in accordance with the present invention is explained as follows.

Detecting Method

The detection is executed by preparing a detecting window in the vicinity of an exit for the specimen solution in the silica pillar structure (on-column detection) or by connecting a detecting cell to the exit for the specimen solution in the silica pillar structure. The detection may be executed by a fluorescence method, a luminescence method, a light absorption method, a refractive index method, a thermal conductivity method, a thermal lens method, a chemiluminescence method or a plasmon resonance method, but is not limited to these methods.

A method for producing the structure in accordance with the present invention is explained as follows.

Producing Method

A structure as shown in FIG. 1 can be prepared by the following steps (A)-(C).

Step (A): Preparation of Reaction Solution

In this step, an inorganic oxide precursor is dissolved in a solvent to obtain a reaction solution. The reaction solution is required to be regulated at a composition capable of forming the pillars. Such a composition, which is capable of forming the pillars, can be selected from a composition showing a more gradual sol-gel transition, in comparison with a composition generating a three-dimensional network porous member by a sol-gel transition. The inorganic oxide precursor can be, for example, a metal alcoxide or a metal chloride. In particular, a silicon alcoxide, such as tetramethoxysilane or tetraethoxysilane, or a silicon chloride, such as tetrachlorosilane, is advantageously employed because of easy reaction control. Also for controlling the phase separation to be explained later and controlling the viscosity of the gel phase in the course of a reaction, a 3- or 2-functional alcoxide having an alkyl chain, such as methyltrimethoxysilane, ethyltrimethoxysilane or dimethoxydimethylsilane, is preferably employed. Also, a plurality of such different precursors may be employed in a mixture.

As the solvent, an alcohol such as methanol or ethanol is advantageously employed, but any other solvent, such as formamide, water or a mixture thereof, may be employed as long as it is capable of dissolving a raw material of the inorganic oxide and inducing the phase separation, thereby forming the pillars. Also, water is required in hydrolyzing the inorganic oxide precursor, and is preferably contained in the solvent. Also, for inducing the phase separation, an additive, such as a water-soluble organic polymer or a surfactant, may be mixed in the reaction solution. Also, an acid, such as nitric acid or hydrochloric acid, may be added as a catalyst to the reaction solution.

The mixing ratio of such a solvent, inorganic oxide precursor, additive, catalyst and the like may be suitably regulated to control the shape of the formed pillars, such as diameter, gap and density, and the co-existing ratio and the shape of a three-dimensional network porous region.

Also, for controlling the hydrolysis/condensation reaction in the reaction solution, it is preferable to control the time and temperature of the period to the step (B).

Step (B): Introduction of Reaction Solution

In this step, the reaction solution is introduced to fill the inner space of the hollow member. The introduction into the inner space can be easily achieved by immersing an end (opening portion to the inner space) of the aforementioned hollow member into the reaction solution and utilizing a capillary action, but another method may also be employed, such as pressurizing the inner space or reducing the pressure thereof thereby forcing the reaction solution into the inner space. The inner space filled with the reaction solution is preferably closed tightly in order to avoid a change in the composition of the reaction solution by solvent evaporation. Such closing may be achieved by sealing the opening portion of the hollow member or by holding the hollow member in another container and by tightly closing such container. Also, for preventing the compositional change of the reaction solution in the inner space, the hollow member filled with the reaction solution is preferably held together with the remaining reaction solution in the container.

Step (C): Phase Separation and Sol-Gel Transition

This step induces phase separation and sol-gel transition in the inner space, thereby forming pillars. By maintaining the hollow member filled with the reaction solution under appropriately controlled reaction conditions, the inorganic oxide precursor causes a hydrolysis/condensation reaction and can cause phase separation in the course of such a reaction. The phase-separated structure can be frozen by sol-gel transition, taking place parallel to the phase separation. In the present invention, through selection of the composition and reacting conditions of the reaction solution, a phase-separated pillar shaped structure is formed in the inner space of the hollow member, and the structure is frozen by sol-gel transition. Therefore, in the step (C), the reaction conditions, such as reaction time and reaction temperature, are suitably determined according to the composition of the reaction solution in the step (A). In this instance, it is also possible, by changing such reaction conditions, to control the shape of the formed pillars, such as diameter, gap and density, and the co-existing ratio and the shape of the three-dimensional network porous region. However, the reaction temperature is selected within a range where the solvent of the reaction solution does not solidify or evaporate, preferably within a range of 0-100° C.

After the aforementioned operation, the solvent may be removed from the inner space. The solvent removal can be performed by opening the inner space, which is closed in the step (B), to evaporate the solvent. Heating is preferably conducted to accelerate the solvent evaporation. It is also possible to conduct the heating at a higher temperature, thereby accelerating the condensation reaction and strengthening the pillars.

The steps (A) to (C) described above allow to form a structure with an inner space, having plural pillars in the inner space. In the structure of the present invention, as the pillar is formed from a material containing an inorganic oxide and different in composition from the material constituting the hollow member with the inner space, fewer limitations are encountered in comparison with a case where the external space and the pillars are formed from the same material, such as an organic polymer. Therefore, an inexpensive structure can be obtained.

As the pillars are formed in the direction parallel to the gravitational direction when the hollow member filled with the reaction solution is allowed to stand, so that the shape of the hollow member and the direction of maintaining the hollow member, filled with the reaction solution, are preferably selected in consideration of the direction of forming the pillars. Also, in the present invention, the hollow member is not restricted in composition and can be suitably selected as long as it can be filled with the reaction solution in the inner space and can form pillars in the inner space, so that the hollow member and the pillars may have different compositions and the pillars can be given a wider design freedom.

A separating element or a capturing element can be prepared by fixing or carrying, on the surface of the pillars in the structure prepared by the above-described producing method, an interacting component capable of executing a physical or chemical interaction with a target substance, or a capturing component.

A method of fixing or carrying such components is explained below.

Such interacting component or capturing component is fixed or carried on the pillars, for example, by covalent bonding, ion bonding or adsorption, but the method is not limited thereto as long as the component can be satisfactorily fixed or carried.

In case of using a bonding method, an interacting component or a capturing component, having a reactive group capable of directly acting on the pillar surface, may be directly reacted to form a bond. Otherwise, a bond may be formed by reacting a crosslinking material, capable of directly acting on the pillar surface, and then reacting an interacting component or a capturing component with such a crosslinking material. For example, if the inorganic oxide is silica, the interacting component or the capturing component may be bonded, utilizing a silanol group present on the surface. It is also possible to react a crosslinking material, such as a silane coupling agent, with the silanol group and to bond the interacting component or the capturing component with the silane coupling agent.

In case of using an adsorption method, a combination of the interacting component or the capturing component and the material of the pillars may be so selected as to have an appropriate affinity. It is also possible to once modify the pillar surface to obtain a surface having an appropriate affinity and to fix the interacting component or the capturing component.

Also, the separating component or the capturing component may be carried via metal particles or a thin metal film, and such method is advantageous if surface plasmon resonance is utilized for detection.

In the following, the present invention is described further by referring to examples, but the present invention is not limited to such examples, and materials, compositions, reacting conditions and the like may be arbitrarily changed within a range capable of obtaining a structure, a separating element, a separating apparatus, a capturing element, and a detecting apparatus of equivalent functions.

### EXAMPLE 1

This example shows a case of employing a glass capillary as the hollow member having an inner space and using a reaction solution constituted of methanol, methyltrimethoxysilane and nitric acid to form plural pillars in the inner space, thereby preparing a structure.

At first, 1.56 ml of methanol and 1.36 ml of a 1N aqueous solution of nitric acid were mixed and agitated under cooling with ice. Then, 5.0 ml of methyltrimethoxysilane was added and the mixture was agitated for 5 minutes under cooling with ice to obtain a reaction solution. This reaction solution was transferred to a closable resin container, and an end of the glass capillary was contacted with the reaction solution to fill the capillary with the reaction solution. The capillary had an inner space with a height of 100 μm, a width of 1 mm and a length of 50 mm. Then, the capillary, filled with the reaction solution, was immersed in the reaction solution contained in the resin container, which was then closed tightly. The closed container was allowed to stand for 24 hours in an oven at 40° C., and then the resin container was opened and further allowed to stand for 24 hours in an oven at 40° C. After these operations, the glass capillary was taken out from the resin container and a cross-sectional shape was observed by using a field emission scanning electron microscope (FE-SEM). It was confirmed that a plurality of pillars were formed in the inner space, in a direction parallel to the gravitational direction applied on the capillary while standing.

Through the above-described operations, methyltrimethoxysilane caused a hydrolysis/condensation reaction to form pillars of a silica-containing material in the glass capillary as shown in FIG. 3, thereby providing the structure of the invention.

### EXAMPLE 2

This example shows a case of employing a glass capillary as the hollow member having an inner space and using a reaction solution constituted of methanol, methyltrimethoxysilane and nitric acid to form plural pillars in the inner space, thereby preparing a structure. In comparison with Example 1, this example is different particularly in the amount of methanol. The structure of the formed pillars can be changed by changing the amount of solvent as shown in this example.

At first, methanol and 1.36 ml of a 1N aqueous solution of nitric acid were mixed and agitated under cooling with ice. Three solutions were prepared by changing the amount of methanol as 1.49 ml (solution A), 1.56 ml (solution B) and 1.59 ml (solution C). Then, 5.0 ml of methyltrimethoxysilane was added to each solution and the mixture was agitated for 5 minutes under cooling with ice to obtain reaction solutions A, B and C. Each of these reaction solutions was transferred to a closable resin container, and an end of the glass capillary was contacted with the reaction solution to fill the capillary with the reaction solution. The capillary had an inner space with a height of 100 μm, a width of 1 mm and a length of 50 mm. Then, the capillary, filled with the reaction solution, was immersed in the reaction solution contained in the resin container, which was then closed tightly. The closed container was allowed to stand for 24 hours in an oven at 40° C., and then the resin container was opened and further allowed to stand for 24 hours in an oven at 40° C. After these operations, the glass capillary was taken out from the resin container and a cross-sectional shape was observed by using a field emission scanning electron microscope (FE-SEM). It was confirmed that a plurality of pillars were formed in the inner space of the glass capillary.

Through the above-described operations, methyltrimethoxysilane caused a hydrolysis/condensation reaction to form pillars of a silica-containing material in the glass capillary, thereby providing the structure of the invention.

The height of the pillars in the capillary increased in the order of the reaction solutions A<B<C, and a three-dimensional network porous region formed at the same time decreased in the order of the reaction solutions A>B>C. In this manner, the structure of the formed pillars can be changed by changing the solvent amount. Also, as to the solvent, the structure of the pillars can be changed not only by the solvent amount but also by changing the type of solvent, for example, by employing another solvent of a different polarity, or employing a mixture of plural solvents.

### EXAMPLE 3

This example shows a case of employing a glass capillary as the hollow member having an inner space, and using a reaction solution constituted of methanol, methyltrimethoxysilane, ethyltrimethoxysilane and nitric acid to form plural pillars in the inner space, thereby preparing a structure. The present example employed two inorganic oxide precursors in a mixture. The structure of the formed pillars can be changed by changing the type of the inorganic oxide precursor as shown in this example.

At first, 0.74 ml of methanol and 1.36 ml of a 1N aqueous solution of nitric acid were mixed and agitated under cooling with ice. Then, 4.75 ml of methyltrimethoxysilane and 0.2791 ml of ethyltrimethoxysilane were added and the mixture was agitated for 5 minutes under cooling with ice to obtain a reaction solution. The reaction solution was transferred to a closable resin container, and an end of the glass capillary was contacted with the reaction solution to fill the capillary with the reaction solution. The capillary had an inner space with a height of 100 μm, a width of 1 mm and a length of 100 mm. Then, the capillary, filled with the reaction solution, was immersed in the reaction solution contained in the resin container, which was then closed tightly. The closed container was allowed to stand for 24 hours in an oven at 40° C., and then the resin container was opened and further allowed to stand for 24 hours in an oven at 40° C. After these operations, the glass capillary was taken out from the resin container and a cross-sectional shape was observed by using a field emission scanning electron microscope (FE-SEM). It was confirmed that a plurality of pillars were formed in the inner space of the glass capillary.

Through the above-described operations, methyltrimethoxysilane and ethyltrimethoxysilane caused a hydrolysis/condensation reaction to form pillars of a silica-containing material in the glass capillary, thereby providing the structure of the invention.

In comparison with Example 1, the present example provided pillars larger in diameter and height. It is therefore advantageous in that the strength of the pillars has been increased.

In this manner, the structure of the formed pillars can be changed by changing the type of the inorganic oxide precursor or by employing a mixture thereof.

### EXAMPLE 4

This example shows a case of employing a glass capillary as the hollow member having an inner space, and a reaction solution constituted of methanol, methyltrimethoxysilane and nitric acid to form plural pillars in the inner space, thereby preparing a structure. The present example employed a lower reaction temperature in comparison with Example 1. The structure of the formed pillars can be changed by changing the reaction temperature as shown in this example.

At first, 0.88 ml of methanol and 1.36 ml of a 1N aqueous solution of nitric acid were mixed and agitated under cooling with ice. Then, 5.0 ml of methyltrimethoxysilane was added and the mixture was agitated for 5 minutes under cooling with ice to obtain a reaction solution.

The reaction solution was transferred to a closable resin container, and an end of the glass capillary was contacted with the reaction solution to fill the capillary with the reaction solution. The capillary had an inner space with a height of 100 μm, a width of 1 mm and a length of 50 mm. Then, the capillary, filled with the reaction solution, was immersed in the reaction solution contained in the resin container, which was then closed tightly. The closed container was allowed to stand for 48 hours in an oven at 10° C., and then the resin container was opened and further allowed to stand for 24 hours in an oven at 40° C. After these operations, the glass capillary was taken out from the resin container and a cross-sectional shape was observed by using a field emission scanning electron microscope (FE-SEM). It was confirmed that a plurality of pillars were formed in the inner space of the glass capillary.

Through the above-described operations, methyltrimethoxysilane caused a hydrolysis/condensation reaction to form pillars of a silica-containing material in the glass capillary, thereby providing the structure of the invention.

In comparison with Example 1, the present example provided pillars larger in diameter and height. It is therefore advantageous in that the strength of pillars has been increased. Also, because of the reaction conducted at a lower temperature, the reaction solution showed little change in composition, by, for example, solvent evaporation, thereby enabling stable formation of the structure.

In this manner, the structure of the formed pillars can be changed by changing the reaction temperature.

### EXAMPLE 5

This example shows a case of employing a glass capillary as the hollow member having an inner space, and using a reaction solution constituted of methanol, methyltrimethoxysilane and nitric acid to form plural pillars in the inner space, thereby preparing a structure. The present example employed a reduced amount of nitric acid, in comparison with Example 1. The structure of the formed pillars can be changed by changing the amount of the acid employed as a catalyst or that of water as a polar solvent as shown in this example.

At first, 1.61 ml of methanol and 1.10 ml of a 1N aqueous solution of nitric acid were mixed and agitated under cooling with ice. Then, 5.0 ml of methyltrimethoxysilane was added and the mixture was agitated for 5 minutes under cooling with ice to obtain a reaction solution. The reaction solution was transferred to a closable resin container, and an end of the glass capillary was contacted with the reaction solution to fill the capillary with the reaction solution. The capillary had an inner space with a height of 100 μm, a width of 1 mm and a length of 100 mm. Then, the capillary, filled with the reaction solution, was immersed in the reaction solution contained in the resin container, which was then closed tightly. The closed container was allowed to stand for 48 hours in an oven at 10° C., and then the resin container was opened and further allowed to stand for 24 hours in an oven at 40° C. After these operations, the glass capillary was taken out from the resin container and a cross-sectional shape was observed by using a field emission scanning electron microscope (FE-SEM). It was confirmed that a plurality of pillars were formed in the inner space of the glass capillary.

Through the above-described operations, methyltrimethoxysilane caused a hydrolysis/condensation reaction to form pillars of a silica-containing material in the glass capillary, thereby providing the structure of the invention.

In comparison with Example 4, the present example provided pillars smaller in diameter and larger in number per unit volume. It is therefore advantageous in that the surface area of the structure has been increased. In this manner, the structure of the formed pillars can be changed by changing the amount of the acid as a catalyst or of water as a polar solvent.

### EXAMPLE 6

The present example shows a method for preparing a separating element by fixing an octadecyl group, as an interacting component with a target substance, on the structure prepared in Example 1.

At first, the structure described in Example 1 was subjected to an ODS (octadecylsilane) modification for use as a reverse-phase column (separating element). The ODS modification was effected by introducing a toluene solution, containing octadecylsilane, into the structure and allowing it to stand at 60° C., thereby chemically modifying the pillar surface with an octadecyl group. The introduction of the solution is preferably performed under pressure with a pump or the like, and a method in which the solution is continuously supplied under a constant pressure or a method of supplying a fixed amount of the solution followed by standing may be adopted as long as a sufficient amount of octadecylsilane can be supplied to the pillar surface. After the reaction, excess octadecylsilane in the structure was removed by rinsing. Also, in order to render the pillar surface more non-polar, the remaining unreacted silanol group was reacted with trimethylchlorosilane by a conventional method (end capping), followed by rinsing.

Through these operations, there was obtained a liquid chromatography column as the separating element, in which an octadecyl group was fixed as a component interacting with a target substance.

### EXAMPLE 7

This example shows a method for preparing a separating apparatus, utilizing the separating element prepared in Example 6, and a method for separating the protein using the apparatus.

Chromatography can be conducted in various modes, such as ion exchange chromatography, gel permeation chromatography, affinity chromatography and reverse-phase chromatography. In the present example, the separating element prepared in Example 6 was employed as a liquid chromatography column. The column was equilibrated with a degassed solvent, and a sample was passed with a developing solvent. In accordance with the present invention, the separating element of the present invention may have a detecting window in the vicinity of the exit for the specimen solution from the silica pillar structure (for on-column detection), and a usual fractionating operation is not required. The eluting protein can be monitored on-line by the UV-VIS method through the detecting window, and the desired component can be recovered when it is eluted.

### EXAMPLE 8

This example shows a method for preparing a capturing element by fixing an anti-troponin antibody as a capturing component on the structure prepared in Example 1. This example shows, for realizing an advantageous combination with a detecting element for detecting a target substance by a plasmon resonance method, a case of carrying fine gold particles on the structure and fixing a capturing component on such fine gold particles.

At first, the surface of the structure described in Example 1 was subjected to amination for carrying fine gold particles. For this purpose, the pillar surface was chemically modified with amino groups by introducing an ethanol solution containing aminosilane into the structure and allowing it to stand at a temperature of 80° C. Introduction of the solution is preferably performed under pressure with a pump or the like. In this instance, the solution may be supplied under a constant pressure, or a fixed amount of the solution may be supplied and then allowed to stand for some time, as long as a sufficient amount of aminosilane can be supplied to the pillar surface. After the reaction, excess aminosilane in the structure was removed by rinsing. Also, for other modification reactions to be described later, a similar method is preferably employed for introducing the reaction solution.

Then, a solution containing fine gold particles of a particle size of 20-40 nm was introduced into the capillary to obtain by an interaction with the amino group, pillars on which the fine gold particles were fixed. Then, in the composite members of the pillars and the fine gold particles, the gold particles were subjected to a surface modification with an ethanol solution of 11-mercaptoundecanoic acid having a thiol group having a high affinity to gold. Thus, a carboxyl group was exposed on the gold particle surface. In this state, an aqueous solution of N-hydroxysulfosuccinimide and an aqueous solution of 1-ethyl-3-[3-dimethylaminopropyl]carbodiimide hydrochloride were introduced. Thereby, a succinimide group was exposed on the surface of the gold particles. Then, streptoavidin was bonded to modify the gold particle surface. Then, a biotinated anti-troponin antibody was reacted with the gold particle surface to fix said antibody as a capturing component for the target substance.

FIG. 4 is a schematic view of the detecting apparatus of the present example, including a tungsten lamp 401, a collimating lens 403, a reaction area (capillary flow path) 404 in the element and a spectrophotometer 408. The present example employed a tungsten lamp 401 emitting white light, but a laser light may also be employed. A light 402 emitted from the tungsten lamp 401 is converted into a parallel beam by the collimating lens 403 and enters the reaction area 404 of the capturing element, including plural pillars 405 formed on a substrate. Fine gold particles 406 are fixed on the surface of the pillars 405. The incident light 402 passes through the reaction area 404 in the pillar-containing element and emerges from the reaction area 404 as an emergent light 407, which enters the spectrophotometer 408. An inlet 409 and an outlet 410 of the element are connected to a solution supply apparatus, such as a pump.

As an actual measurement, detection of troponin-T, known as a marker of acute myocardial infarction, is conducted. The antigen troponin-T is specifically bonded by the following procedure:
(1) A solution of antigen troponin-T was introduced into the capillary flow path through the inlet 409 shown in FIG. 4, and the element was incubated for 5 minutes; and
(2) The antigen solution was extracted, and the element was rinsed with a phosphate buffer.

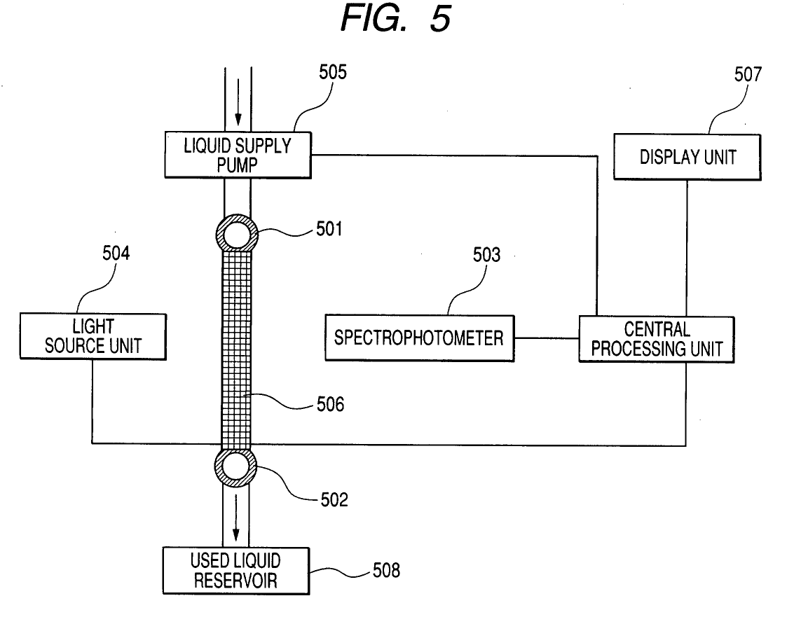

FIG. 5 is a block diagram of the detecting apparatus utilizing the capturing element. The position of the capturing element is regulated so that the reaction region is present on the optical axis of a spectrophotometer 503 and a light source 504. In this state, a spectrum prior to the reaction is measured in advance by the spectrophotometer 503. Then, a solution supply pump 505 is activated to supply a reaction area 506 of the detecting element with a predetermined amount of a specimen from an inlet 501, thereby causing the fine gold particles to capture the target substance, via the antibody utilizing an antigen-antibody reaction. After the reaction, a spectrum is measured by the spectrophotometer 503 and is compared with the spectrum before the reaction. A difference between the spectra indicates a change in a localized plasmon resonance state of the fine gold particles caused by the capture of the target substance in the vicinity of the gold particles. The concentration of the target substance is determined from the change in the spectrum and is displayed on the display unit 507. In FIG. 5, the solution is discharged from an outlet 502 and is stored in a used solution reservoir 508.

The relationship between the change in the spectrum and the concentration of the target substance is obtained in advance, utilizing plural standard specimens of known concentrations. A calibration curve is obtained from the relationship, thereby determining a function between the spectrum change and the concentration. In an actual measurement, such a function is utilized to determine the unknown concentration of the target substance based on the spectrum change. The change in spectrum mentioned above may be a change in a spectral peak at a wavelength where the spectral peak reaches a maximum, or a change in a spectral peak shape, such as a half-peak width of the spectral peak. Also, a change in light intensity at one or plural wavelengths may be utilized.

### EXAMPLE 9

This example shows the preparation of a detecting apparatus utilizing the capturing element prepared in Example 4, which was used for detection of PSA, known as a prostate cancer marker. The present example shows a useful application of a detecting element for detecting the presence of a target substance by a fluorescence method.

The pillar surface was subjected to amination with aminosilane, as described in Example 8. Then, the amino group on the surface was activated by reaction with a 2% glutaraldehyde solution at 37° C. for about 2 hours. After rinsing with deionized water, a phosphoric acid buffer containing an anti-PSA antibody was introduced and allowed to stand at 37° C. for 2 hours to form a covalent bond between the active groups on the pillar surface and amino groups contained in the antibody, thereby fixing the anti-PSA antibody 605 as a capturing component.

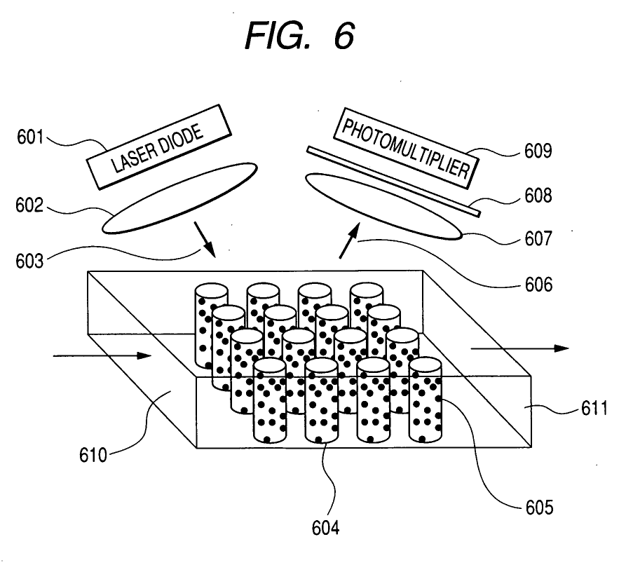

As an actual measurement, detection is tried on PSA, which is known as a prostate cancer marker. The antigen PSA is specifically captured by the following procedure, while a detecting optical system is shown in FIG. 6:
(1) A solution of antigen PSA is introduced from an inlet 610 into a reaction area 604, and incubated for 5 minutes;
(2) The antigen solution is extracted from an outlet 611, and the element is rinsed with a phosphoric acid buffer;
(3) An anti-PSA antibody, fluorescently labeled with Cy5 dye, is introduced from the inlet 610 into the reaction area 604, and incubated for 5 minutes;
(4) The labeled antibody is extracted from the outlet 611, and the element is rinsed with a phosphoric acid buffer; and
(5) The phosphoric acid buffer is introduced to fill the reaction region 604.

After these steps, an exciting light 603 is introduced, from a laser diode 601 and through a collimating lens 602, into the reaction region 604 whereby a fluorescence from the antibody, captured on the pillar surface, can be observed. Based on the intensity of the fluorescence, which will vary depending on the concentration of the fluorescent dye, the concentration of the target substance can be determined. In FIG. 6, a fluorescence (emerging light 606) from the reaction region 604 is measured through a collimating lens 607, a filter 608 and a photomultiplier 609.

### EXAMPLE 10

The present example shows a case of forming pillars on a thin gold film on a sensor substrate, then fixing an anti-troponin antibody as a capturing component on the structure including the pillars, and detecting the presence of a target substance by using a surface plasmon resonance (SPR) sensor.

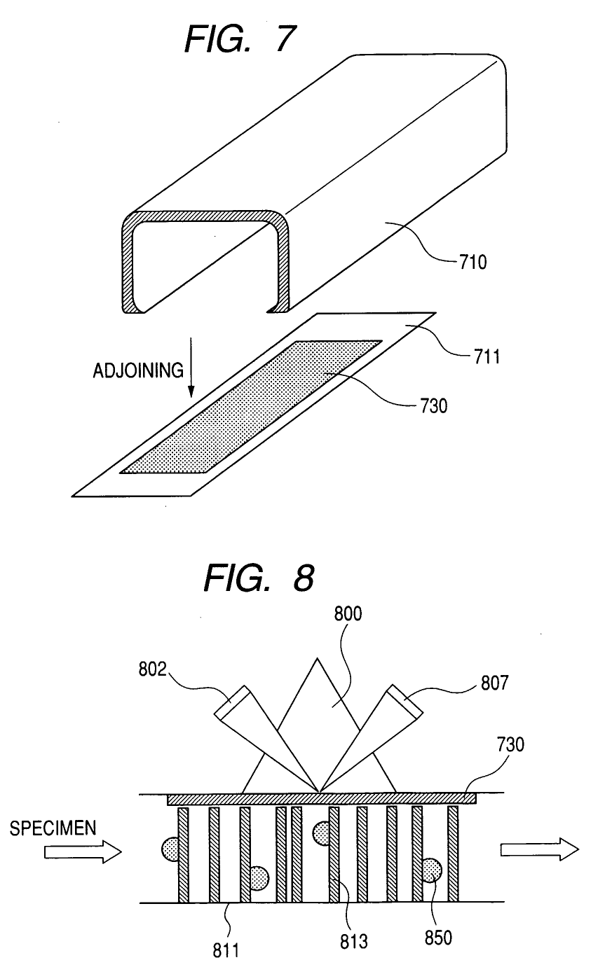

At first, plural pillars are prepared in the inner space by a process similar to that in Example 1, thereby preparing a structure. The hollow member having the inner space preferably has a planar part as shown in FIGS. 2A and 2B. The member is prepared, as shown in FIG. 7, by depositing a thin gold film 730 (thickness 50 nm) on a glass substrate 711 and then adjoining a glass flow path 710 which is open on a face thereof.

In the pillar-forming step, the hollow member is preferably allowed to stand in such a position that the gold film-bearing face is located at the top or at the bottom in order to improve the sensitivity of the SPR sensor. In this manner, a flow path for a specimen, having pillars on the thin gold film, can be obtained.

The pillar surface is subjected to amination by introducing an ethanol solution containing aminosilane into the structure, as explained in Example 8. Then, the amino groups on the surface are activated by a reaction with a 2% glutaraldehyde solution (37° C., 2 hours). After rinsing with deionized water, a phosphoric acid buffer containing an anti-troponin antibody is introduced and allowed to stand at 37° C. for 2 hours, thereby forming a covalent bond between the active groups on the pillar surface and the amino group contained in the antibody, thereby fixing the anti-troponin antibody as a capturing component.

As an actual measurement, detection is tried on troponin-T. The antigen troponin-T is specifically captured by the following procedure. The detecting optical system is an SPR measuring system of a Kretschmann configuration as shown in FIG. 8, which shows a prism 800, an incident light (polarized light) 802, a reflected light 807, a thin gold film 730 as shown in FIG. 7, pillars 813 fixing the capturing component on the surface thereof, and a hollow member 811 having an internal structure. By passing a specimen through the hollow member 811, a target substance 850 contained in the specimen is captured on the surface of the pillars 813 fixing the capturing component.

Then, the incident (polarized) light 802 is introduced through the prism 800 into the gold film 730, and a change in an angle (resonance angle) of a dark line, generated in the reflected light 807, is recorded as a sensorgram.

A change in the resonance angle, induced by association or dissociation of a molecule to or from the sensor surface, is proportional to a weight change of the captured molecule and is recorded as a sensorgram, and the concentration of the target substance can be measured by such a change.

The pillared structure of the present example, in consideration of a detection range (evanescent region) perpendicular to the gold film of the SPR sensor, can efficiently capture and detect the target substance within the inner space, thus enabling an improvement in the sensitivity.

This application claims priority from Japanese Patent Application No. 2005-079956, filed Mar. 18, 2005, which is hereby incorporated herein by reference.

1. A structure, having an opening communicating with an inner space, adapted for separating or capturing a substance introduced from the opening into the inner space, the structure comprising:
a hollow member having the inner space and the opening; and
plural pillars positioned mutually separately in the inner space,
wherein the pillars are formed of a material containing an inorganic oxide and different in composition from the hollow member.

2. A structure according to claim 1, wherein the inorganic oxide is silica.

3. A structure according to claim 1, wherein the pillars contain carbon.

4. A separating element, having an opening communicating with an inner space, adapted for separating a target substance contained in a specimen introduced from the opening into the inner space, the element comprising:
a structure according to claim 1; and
a separating component, provided on a surface of the pillars, capable of having an interaction with the target substance to thereby perform separation of the target substance from the specimen.

5. A separating apparatus, adapted for separating a target substance contained in a specimen, comprising:
a separating element according to claim 4; and
displacement means for causing fluid displacement within the inner space of the separating element.

6. A separating apparatus according to claim 5, further comprising detection means for detecting a separation state of the target substance.

7. A separating apparatus according to claim 6, wherein the detection means is capable of optically detecting a separation state of the target substance.

8. A capturing element, adapted for capturing a target substance contained in a specimen, comprising:
a structure according to claim 1; and
a capturing component, provided on a surface of the pillars, capable of capturing the target substance.

9. A detecting apparatus, adapted for detecting a target substance, comprising:
a capturing element according to claim 8; and
detecting means for detecting that the target substance is captured by the capturing element.

10. A detecting apparatus according to claim 9, wherein the detecting means is capable of optically detecting that the target substance is captured.

11. A detecting apparatus according to claim 9, wherein the detecting means utilizes at least a method selected from a fluorescence method, a luminescence method, a light absorption method, a refractive index method, a thermal conductivity method, a thermal lens method, a chemiluminescence method and a plasmon resonance method.

12. A method of separating a target substance contained in a specimen, comprising:
a step of contacting the specimen with a separating element according to claim 4; and
a step of separating the target substance from the specimen, utilizing a physical or chemical interaction of the separating element with the target substance, the interaction being caused to occur in the contacting step.

13. A method of separating a target substance according to claim 12, wherein the target substance is selected from an organic compound and a phosphoric acid compound.

14. A method of detecting a target substance contained in a specimen, comprising:
a step of contacting the specimen with a capturing element according to claim 8; and
a step of detecting a physical or chemical change resulting from a capture of the target substance by the capturing element.

15. A method of detecting a target substance according to claim 14, wherein the target substance is selected from an organic compound and a phosphoric acid compound.

16. A method of producing a structure provided, in a hollow member having an inner space, with pillars in the inner space, comprising:
a step of preparing a reaction solution dissolving an inorganic oxide precursor and having a composition regulated to form the pillars;
a step of introducing the reaction solution to fill the inner space; and
a step of inducing phase separation and sol-gel transition in the inner space to thereby form the pillars in a direction parallel to the gravitational direction.

17. A method of producing a structure according to claim 16, wherein the inorganic oxide precursor is a metal alcoxide.

18. A method of producing a structure according to claim 17, wherein the metal alcoxide is silicon alcoxide.
